(19) United States
(12) Patent Application Publication
(10) Pub. No.: US 2008/0144189 A1
(43) Pub. Date: Jun. 19, 2008

(54) Zoom lens and imaging apparatus

(75) Inventors: Yoshito Iwasawa, Tokyo (JP); Yasushi Yamamoto, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/980,457

(22) Filed: Oct. 31, 2007

(30) Foreign Application Priority Data
Dec. 13, 2006 (JP) 2006-336125

(51) Int. Cl. G02B 15/177

(52) U.S. Cl. 359/686

(57) ABSTRACT

There is provided a zoom lens, including, in an order from an object side to an image side, a first lens group having a negative refractive power; a second lens group having a positive refractive power; a third lens group having a negative refractive power; and a fourth lens group having a positive refractive power. During power variation from a wide angle end to a telephoto end, each group is moved in an optical axis direction, and a following conditional expression (1) is satisfied:

−5<f4/f1<−2.6, where: (1)
f1 is a focal length of the first lens group; and
f4 is a focal length of the fourth lens group.

### BACKGROUND OF THE INVENTION

1. Field of the Invention

The present invention relates to a zoom lens and imaging apparatus. More particularly, the present invention relates to a zoom lens which is suitable for an interchangeable lens attachable to a silver-salt-film single-lens reflex camera or a digital single-lens reflex camera and which is highly efficient and capable of sufficiently securing a back focus, and the present invention relates also to an imaging apparatus using the zoom lens.

2. Description of the Related Art

Recently, an increase in number of pixels of an image sensor formed of a photoelectric converter leads to a demand of a higher-quality image taking optical system, and in addition, a demand of a zoom lens with small F-numbers covering a wide-angle range and which includes an ultra wide viewing angle.

Further, there is a restriction that the interchangeable lens simultaneously needs to secure a sufficient back focus.

For example, in Japanese Patent Application Publication (KOKAI) No. 2005-106878 (Patent Document 1), proposed is an ultra-wide-angle zoom lens having an angle of view at a wide end of 122 degrees, which is achieved by a 4-group zoom configuration in which a negative first lens group; a positive second lens group; a negative third lens group; and a positive fourth lens group are aligned in order from an object side.

### SUMMARY OF THE INVENTION

Incidentally, in the zoom lens proposed in Patent Document 1, an effective aperture on the object side is very large, and the F-number is about 5.6 at a telephoto end.

The present invention has been achieved in view of the problem, and in particular, there is a need of providing a highly efficient and compact zoom lens which is suitable for an interchangeable lens attachable to a silver-salt-film single-lens reflex camera or a digital single-lens reflex camera, capable of sufficiently securing a back focus, and providing also an imaging apparatus using the zoom lens.

A zoom lens according to one embodiment of the present invention includes, by aligning in an order from an object side to an image side: a first lens group having a negative refractive power; a second lens group having a positive refractive power; a third lens group having a negative refractive power; and a fourth lens group having a positive refractive power. During power variation from a wide angle end to a telephoto end, each group is moved in an optical axis direction, and a following conditional expression (1) is satisfied, where f1 denotes a focal length of the first lens group and f4 denotes a focal length of the fourth lens group:

−5<f4/f1<−2.6. (1)

Further, an imaging apparatus according to one embodiment of the present invention is provided with: a zoom lens; and an image sensor for converting an optical image formed with the zoom lens into an electric signal. The zoom lens is configured by aligning in an order from an object side to an image side: a first lens group having a negative refractive power; a second lens group having a positive refractive power; a third lens group having a negative refractive power; and a fourth lens group having a positive refractive power. During variable power from a wide angle end to a telephoto end, each group is moved in an optical axis direction, and a following conditional expression (1) is satisfied, where f1 denotes a focal length of the first lens group and f4 denotes a focal length of the fourth lens group:

−5<f4/f1<−2.6. (1)

These and other features and aspects of the invention are set forth in detail below with reference to the accompanying drawings in the following detailed description of the embodiments.

### BRIEF DESCRIPTION OF THE DRAWINGS

FIG. 1 is a diagram showing a lens configuration of a first embodiment of a zoom lens of the present invention;

FIG. 2 shows, together with FIG. 3 and FIG. 4, aberration charts of a first numerical embodiment in which specific numerical values are applied to the first embodiment. FIG. 2 shows a spherical aberration, an astigmatism, and a distortion at a wide angle end;

FIG. 3 shows a spherical aberration, an astigmatism, and a distortion at an intermediate focal length;

FIG. 4 shows a spherical aberration, an astigmatism, and a distortion at a telephoto end;

FIG. 5 is a diagram showing a lens configuration of a second embodiment of a zoom lens of the present invention;

FIG. 6 shows, together with FIG. 7 and FIG. 8, aberration charts of a second numerical embodiment in which specific numerical values are applied to the second embodiment. FIG. 6 shows a spherical aberration, an astigmatism, and a distortion at a wide angle end;

FIG. 7 shows a spherical aberration, an astigmatism, and a distortion at an intermediate focal length;

FIG. 8 shows a spherical aberration, an astigmatism, and a distortion at a telephoto end;

FIG. 9 is a diagram showing a lens configuration of a third embodiment of a zoom lens of the present invention;

FIG. 10 shows, together with FIG. 11 and FIG. 12, aberration charts of a third numerical embodiment in which specific numerical values are applied to the third embodiment. FIG. 10 shows a spherical aberration, an astigmatism, and a distortion at a wide angle end;

FIG. 11 shows a spherical aberration, an astigmatism, and a distortion at an intermediate focal length;

FIG. 12 shows a spherical aberration, an astigmatism, and a distortion at a telephoto end;

FIG. 13 is a diagram showing a lens configuration of a fourth embodiment of a zoom lens of the present invention;

FIG. 14 shows, together with FIG. 15 and FIG. 16, aberration charts of a fourth numerical embodiment in which specific numerical values are applied to the fourth embodiment. FIG. 14 shows a spherical aberration, an astigmatism, and a distortion at a wide angle end;

FIG. 15 shows a spherical aberration, an astigmatism, and a distortion at an intermediate focal length;

FIG. 16 shows a spherical aberration, an astigmatism, and a distortion at a telephoto end;

FIG. 17 is a diagram showing a lens configuration of a fifth embodiment of a zoom lens of the present invention;

FIG. 18 shows, together with FIG. 19 and FIG. 20, aberration charts of a fifth numerical embodiment in which specific numerical values are applied to the fifth embodiment. FIG. 18 shows a spherical aberration, an astigmatism, and a distortion at a wide angle end;

FIG. 19 shows a spherical aberration, an astigmatism, and a distortion at an intermediate focal length;

FIG. 20 shows a spherical aberration, an astigmatism, and a distortion at a telephoto end;

FIG. 21 is a diagram showing a lens configuration of a sixth embodiment of a zoom lens of the present invention;

FIG. 22 shows, together with FIG. 23 and FIG. 24, aberration charts of a sixth numerical embodiment in which specific numerical values are applied to the sixth embodiment. FIG. 22 shows a spherical aberration, an astigmatism, and a distortion at a wide angle end;

FIG. 23 shows a spherical aberration, an astigmatism, and a distortion at an intermediate focal length;

FIG. 24 shows a spherical aberration, an astigmatism, and a distortion at a telephoto end; and

FIG. 25 is a block diagram showing one embodiment of an imaging apparatus of the present invention.

### DETAILED DESCRIPTION OF THE EMBODIMENTS

Hereinafter, the best modes for carrying out a zoom lens and an imaging apparatus of the present invention will be described with reference to the drawings.

Firstly, a description is given of a zoom lens of the present invention.

In the zoom lens of the present invention, from an object side to an image side, a first lens group having a negative refractive power; a second lens group having a positive refractive power; a third lens group having a negative refractive power; and a fourth lens group having a positive refractive power are aligned. During variable power from a wide angle end to a telephoto end, each group is moved in an optical axis direction, and the following conditional expression (1) is satisfied:

−5<f4/f1<−2.6, (1)

where:
f1: a focal length of the first lens group; and
f2: a focal length of the fourth lens group.

Therefore, in the zoom lens of the present invention, it may become possible to achieve miniaturization and secure a necessary back focus. It may also become possible to reduce curvature of field that occurs in the first lens group.

The conditional expression (1) defines a ratio of focal length between the first lens group and the fourth lens group. When the conditional expression (1) is satisfied, it may become possible to correct curvature of field at a wide angle end, and at the same time, to secure an appropriate back focus, and further, a front lens diameter can be made small, which contributes to miniaturization.

When a lower limit of the conditional expression (1) is exceeded, the refractive power of the first lens group becomes strong, and thus, it may become difficult to correct the curvature of field that occurs in the first lens group. When an upper limit of the conditional expression (1) is exceeded, the refractive power of the fourth lens group becomes strong, and thus, it may become difficult to secure the necessary back focus. Further, the refractive power of the first lens group becomes weak, and thus, there has no choice but to render the front lens diameter large, which leads to an obstacle against miniaturization.

In the zoom lens according to one embodiment of the present invention, when D3 denotes an optical path diameter of an on-axis bundle on a surface closest to an object of the third lens group at a telephoto end, the following conditional expression (2) is desirably satisfied. Thereby, it may become possible to achieve a small F-number while the curvature of field is properly corrected:

−1.7<D3/f1<−0.95. (2)

The conditional expression (2) defines a ratio between the focal length of the first lens group and the optical path diameter of the on-axis bundle on the surface closest to the object of the third lens group at the telephoto end. When a lower limit of the conditional expression (2) is exceeded, the refractive power of the first lens group becomes too strong, and in particular, it may become difficult to correct the curvature of field at the wide angle end. When an upper limit of the conditional expression (2) is exceeded, the refractive power of the first lens group becomes weak, and in particular, it may become difficult to secure enough illumination at the wide angle end.

In the zoom lens according to one embodiment of the present invention, it is desirable that a whole of the first lens group is moved in the optical axis direction to perform focusing on a close subject. The focusing is performed using the whole of the first lens group in which an aberration correction is sufficiently performed, and thus, it may become possible to perform focusing with a small aberration variation to a proximal area.

In the zoom lens according to one embodiment of the present invention, it is desirable that the first lens group is configured by an object-side sub-group positioned on an object side and an image-plane-side sub-group positioned on an image-plane side, and the image-plane-side sub-group is moved to perform focusing on the close subject. To achieve wide-angle, it is necessary to absorb light in a wider range in the first lens group, and thus, in particular, a front lens becomes large in diameter, and therefore, its weight also becomes heavy. Therefore, the first lens group is divided into the object-side sub-group and the image-plane-side sub-group to achieve a smaller diameter, and therefore, the image-plane-side sub-group that can be more lightly configured is moved on the optical axis to perform the focusing. As a result, while maintaining an advantage in that the focusing is performed by the first lens group, the light weight of a focus group permits further miniaturization of a drive mechanism. For example, it becomes possible to use a drive source small in output such as an ultrasonic motor.

In the zoom lens according to one embodiment of the present invention, when the first lens group is divided into the object-side sub-group and the image-plane-side sub-group, and the focusing is performed in the image-plane-side sub-group, the following conditional expression (3) is desirably satisfied, where f11 denotes a focal length of the object-side sub-group in the first lens group, and f12 denotes a focal length of the image-plane-side sub-group in the first lens group. Thereby, it becomes possible to inhibit the occurrence of a distortion at the time of the focusing.

0.15<f11/f12<0.45 (3)

The conditional expression (3) defines a ratio of focal length between the object-side sub-group of the first lens group and the image-plane-side sub-group thereof. When a lower limit of the conditional expression (3) is exceeded, a refractive power of the image-plane-side sub-group of the first lens group becomes too weak, and thus, a moving amount at the time of the focusing becomes large, which may make it difficult to configure a lens barrel, and hence, not preferable. When an upper limit of the conditional expression (3) is exceeded, the refractive power of the image-plane-side sub-group of the first lens group becomes too strong, and thus, a variation of distortion at the time of the focusing becomes large.

In the zoom lens according to one embodiment of the present invention, it is desirable that a surface closest to the object of the first lens group includes an aspheric surface disposed such that the further away from an optical axis, the stronger a positive refractive power. Thereby, it becomes possible to more effectively correct the distortion and the curvature of field.

Further preferably, a following conditional expression (4) is satisfied:

−45<(|x|−|x0|)/(c0×(N′−N)×f1)<−5, (4)

where:
x denotes a shape of the aspheric surface (distance in an optical axis direction from a vertex of a lens surface);
x0 denotes a shape of a reference sphere of the aspheric surface;
c0 denotes a curvature of the reference sphere of the aspheric surface;
N denotes a refractive index of an object-side medium of the aspheric surface;
N′ denotes a refractive index of an image-side medium of the aspheric surface; and
f1 denotes a focal length of the first lens group.

The conditional expression (4) defines a shape of the aspheric surface disposed on the object side of the first lens group such that the further away from the optical axis, the stronger the positive refractive power. When the conditional expression (4) is satisfied, it becomes possible to properly correct the distortion on a wide-angle side and the spherical aberration on a telephoto side. When a lower limit of the conditional expression (4) is exceeded, a power on the aspheric surface becomes too weak, and it becomes difficult to correct the distortion on the wide-angle side. When an upper limit of the conditional expression (4) is exceeded, the power on the aspheric surface becomes too strong, and it becomes difficult to correct the distortion on the telephoto side. Subsequently, with reference to the drawings and tables, specific examples of the zoom lens according to the embodiments of the present invention and numerical embodiments in which specific numerical values are applied are described.

It is noted that in each of the embodiments, an aspheric surface is introduced, and a shape of the aspheric surface is defined by the following expression 1:

$$x = \frac{{y}^{2} \cdot {c}^{2}}{1 + \sqrt{1 - ɛ \cdot {y}^{2} \cdot {c}^{2}}} + \sum {A}^{i} \cdot {y}^{i} \qquad [ Expression 1 ]$$

In the expression 1, x denotes a distance in the optical axis direction from a vertex of a lens surface; y denotes a height in a direction vertical to the optical axis; c denotes a paraxial curvature at the vertex of the lens surface; ε denotes a conical constant; and Aⁱ denotes an i-th-order aspherical coefficient.

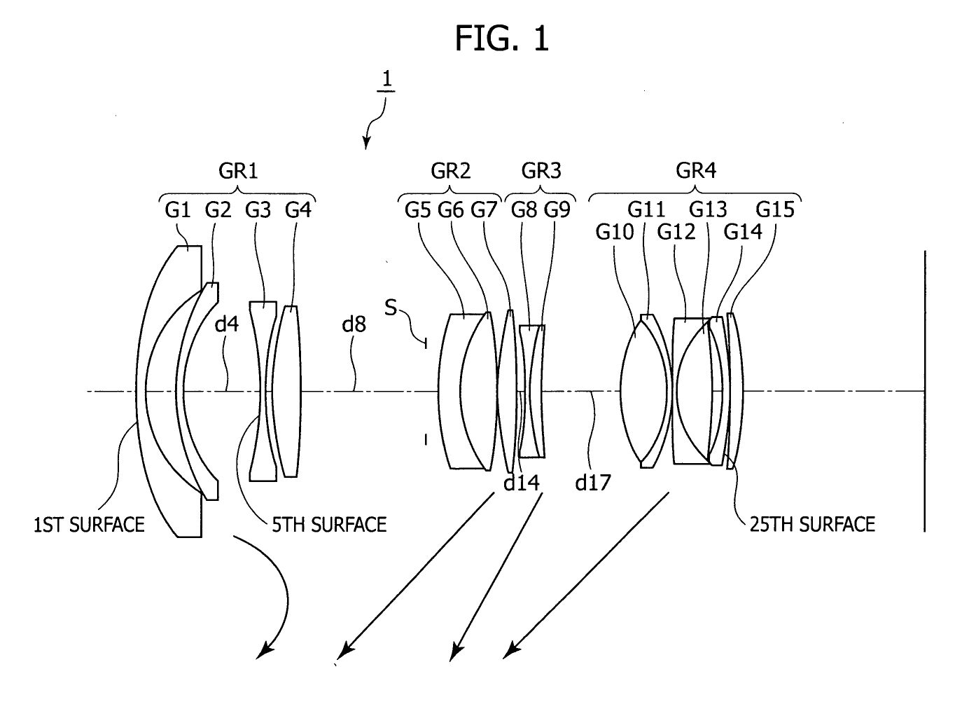

FIG. 1 shows the lens configuration at a wide angle end of a zoom lens 1 according to a first embodiment, in which a moving trajectory on the optical axis toward a telephoto end of each lens group is indicated by an arrow.

The zoom lens 1 includes, in an order from the object side to the image-plane side: a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing in the order from the object side to the image-plane side: an object-side sub-group which includes a negative lens G1 having an aspheric surface on the object side and having a concave surface with a strong curvature on the image side, and a negative lens G2 having a concave surface with a strong curvature on the image side; and an image-side sub-group which includes a negative lens G3 having an aspheric surface on the object side and a positive lens G4. The second lens group GR2 is configured by disposing in the order from the object side to the image-plane side: a cemented lens formed of a negative lens G5 and a positive lens G6; and a positive lens G7. The third lens group GR3 is configured with a cemented lens formed of a negative lens G8 and a positive lens G9, disposed in the order from the object side to the image-plane side. The fourth lens group GR4 is configured by disposing in the order from the object side to the image-plane side: a cemented lens formed of a positive lens G10 and a negative lens G11; a cemented lens formed of a negative lens G12 and a positive lens G13; a negative lens G14 having an aspheric surface on the image side; and a positive lens G15. An aperture stop S is positioned on the object side of the second lens group GR2. The image-plane-side sub-group formed of the third lens G3 and the fourth lens G4, of the first lens group GR1, moves on the optical axis to perform the focusing.

Table 1 shows lens data of a numerical embodiment 1, which are obtained by applying the specific numerical values to the zoom lens 1 according to the first embodiment. In Table 1 and other tables in which lens data are shown, a “Surface No.” indicates an i-th surface counted from the object side; a “Curvature Radius” indicates a radius of paraxial curvature of the i-th surface from the object side; an “Axial Surface Distance” indicates an axial surface distance between the i-th surface and an i+1-th surface; a “Refractive Index” indicates a refractive index on a d-line of a glass material having the i-th surface on the object side; and an “Abbe Number” indicates an Abbe number on the d-line of the glass material having the i-th surface on the object side, respectively. A symbol “*” attached after the surface number i indicates that the surface is an aspheric surface, and a numeral “di” in the axial surface distance indicates that the axial surface distance is a variable distance.

TABLE 1

| | | Axial | | |
|---|---|---|---|---|
| Surface | Curvature | Surface | Refractive | Abbe |
| No. | Radius | Distance | Index | Number |
| 1* | 84.818 | 1.500 | 1.77250 | 49.77 |
| 2 | 20.124 | 5.374 | | |
| 3 | 34.523 | 1.250 | 1.82716 | 45.43 |
| 4 | 22.571 | d4 | | |
| 5* | −52.987 | 1.001 | 1.77250 | 49.77 |
| 6 | 47.706 | 1.254 | | |
| 7 | 45.008 | 5.000 | 1.61094 | 33.57 |
| 8 | −98.015 | d8 | | |
| 9 | Aperture | 2.040 | | |
| | Stop | | | |
| 10 | 40.808 | 3.995 | 1.87454 | 35.15 |
| 11 | 22.226 | 6.244 | 1.56006 | 61.44 |
| 12 | −85.255 | 0.200 | | |
| 13 | 46.066 | 3.374 | 1.77250 | 49.70 |
| 14 | −140.088 | d14 | | |
| 15 | −63.287 | 0.800 | 1.88259 | 40.49 |
| 16 | 35.682 | 2.169 | 1.92286 | 18.89 |
| 17 | 154.181 | d17 | | |
| 18 | 23.905 | 8.179 | 1.49700 | 81.61 |
| 19 | −18.425 | 0.801 | 1.87958 | 38.30 |
| 20 | −25.683 | 0.150 | | |
| 21 | 278.278 | 0.800 | 1.86703 | 31.24 |
| 22 | 16.174 | 5.909 | 1.49700 | 81.61 |
| 23 | −94.802 | 1.999 | | |
| 24 | −28.032 | 1.000 | 1.88300 | 40.80 |
| 25* | −50.093 | 0.150 | | |
| 26 | −214.342 | 2.212 | 1.79876 | 22.61 |
| 27 | −54.130 | | | |

During zooming from the wide angle end to the telephoto end, a distance d8 between the first lens group GR1 and the second lens group GR2 (aperture stop S), a distance d14 between the second lens group GR2 and the third lens group GR3, and a distance d17 between the third lens group GR3 and the fourth lens group GR4 are changed. Therefore, Table 2 shows values of the respective distances d8, d14, and d17 in the numerical embodiment 1 at the wide angle end (f=15.40), an intermediate focal length (f=23.25) between the wide angle end and the telephoto end, and the telephoto end (f=33.99), together with respective values of a focal length f, an F-number FNO, and an angle of view 2ω. A distance d4 between the object-side sub-group and the image-plane-side sub-group in the first lens group GR1 changes during the focusing.

TABLE 2

| | |
|---|---|
| f = | 15.40~23.25~33.99 |
| FNO = | 3.58~3.58~3.60 |
| 2ω = | 111.0~85.1~63.7 |
| d4 = | 13.330~13.330~13.330 |
| d8 = | 22.042~9.327~2.151 |
| d14 = | 1.568~7.822~14.665 |
| d17 = | 13.848~7.594~0.750 |

An object-side surface (first surface) of the first lens G1, an object-side surface (fifth surface) of the third lens G3, and an image-side surface (25th surface) of the 14th lens G14 are configured by aspheric surfaces. Therefore, Table 3 shows aspherical coefficients of the respective surfaces in the numerical embodiment 1, together with conical constants ε.

TABLE 3

| Surface | | | | | |
|---|---|---|---|---|---|
| No. | ε | A⁴ | A⁶ | A⁸ | A¹⁰ |
| 1 | 9.8668 | 0.10690989 × 10⁻⁴ | −0.14223401 × 10⁻⁷ | 0.17283994 × 10⁻¹⁰ | −0.12132212 × 10⁻¹³ |
| 5 | 1 | −0.30646240 × 10⁻⁵ | −0.44595354 × 10⁻⁸ | 0.11684383 × 10⁻⁹ | −0.35067195 × 10⁻¹² |
| 25 | 1 | 0.13814555 × 10⁻⁴ | 0.27805869 × 10⁻⁷ | 0.10618731 × 10⁻⁹ | 0.56273183 × 10⁻¹² |

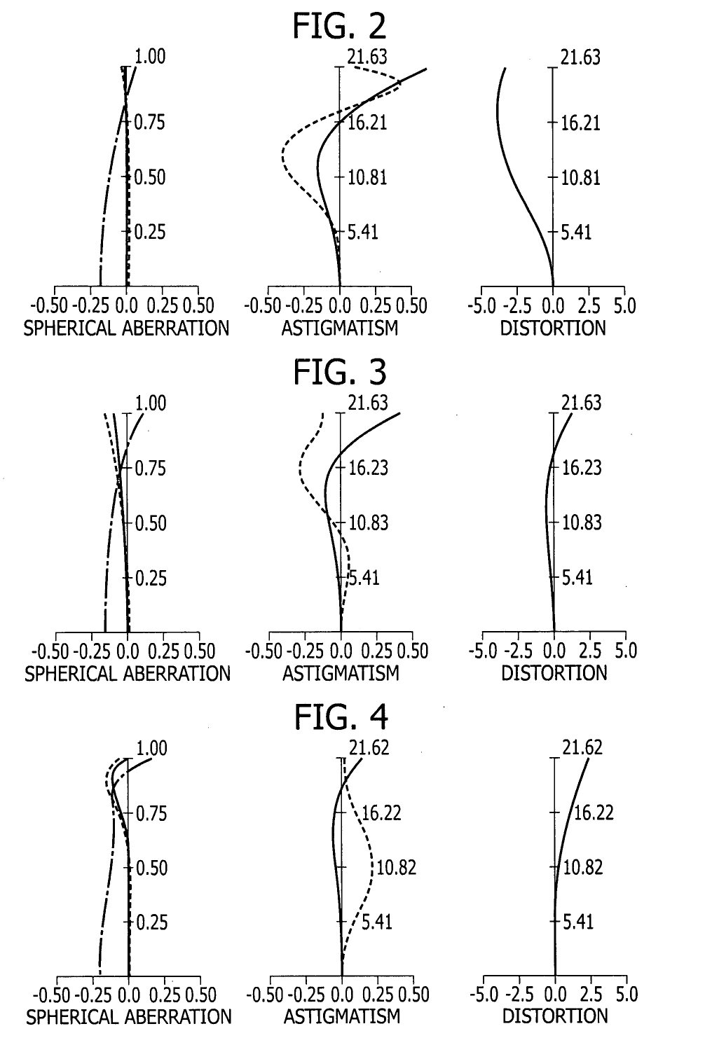

FIG. 2 to FIG. 4 show a spherical aberration, an astigmatism, and distortion, respectively, in focus at infinity in the numerical embodiment 1. FIG. 2 shows the respective aberrations at the wide angle end, FIG. 3 shows those at the intermediate focal length, and FIG. 4 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

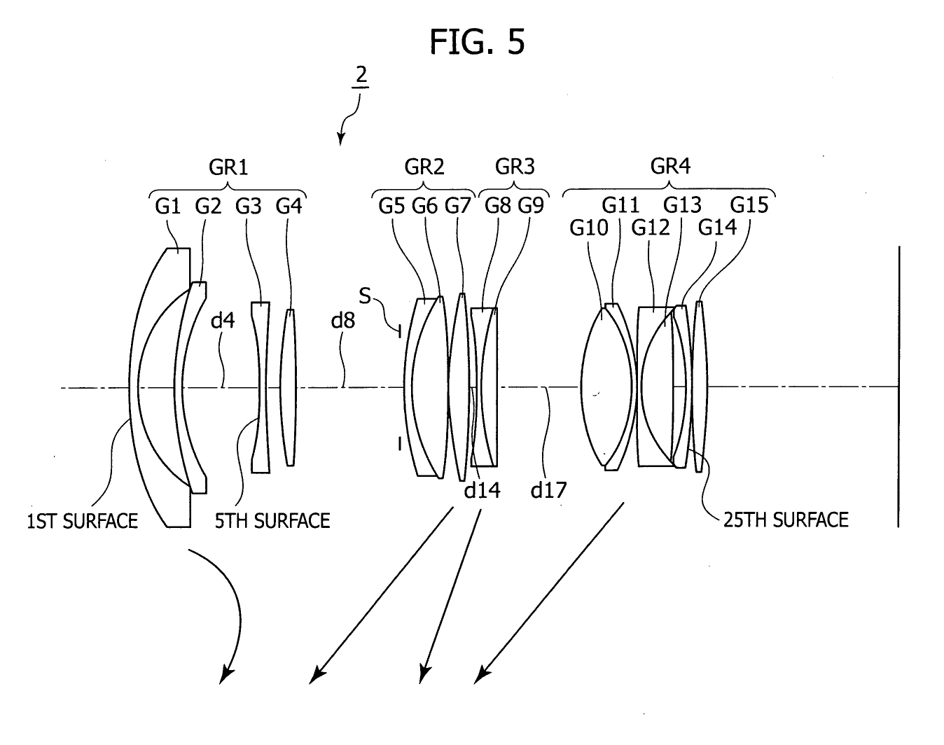

FIG. 5 shows a lens configuration at a wide angle end of a zoom lens 2 according to a second embodiment, in which a moving trajectory on the optical axis toward a telephoto end of each lens group is indicated by an arrow.

The zoom lens 2 is formed by disposing, in the order from the object side to the image-plane side, a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing in the order from the object side to the image-plane side: an object-side sub-group including a negative lens G1 having an aspheric surface on the object side and having a concave surface with a strong curvature on the image side and a negative lens G2 having a concave surface with a strong curvature on the image side; and an image-side sub-group including a negative lens G3 having an aspheric surface on the object side and a positive lens G4. The second lens group GR2 is configured by disposing in the order from the object side to the image-plane side: a cemented lens formed of a negative lens G5 and a positive lens G6; and a positive lens G7. The third lens group GR3 is configured with a cemented lens formed of a negative lens G8 and a positive lens G9, disposed in the order from the object side to the image-plane side. The fourth lens group GR4 is configured by disposing in the order from the object side to the image-plane side: a cemented lens formed of a positive lens G10 and a negative lens G11; a cemented lens formed of a negative lens G12 and a positive lens G13; a negative lens G14 having an aspheric surface on the image side; and a positive lens G15. The aperture stop S is positioned on the object side of the second lens group GR2, and the image-plane-side sub-group formed of the third lens G3 and the fourth lens G4, of the first lens group GR1, moves on the optical axis to perform the focusing.

Table 4 shows lens data of a numerical embodiment 2 in which specific numerical values are applied to the zoom lens 2 according to the second embodiment.

TABLE 4

| | | Axial | | |
|---|---|---|---|---|
| Surface | Curvature | Surface | Refractive | Abbe |
| No. | Radius | Distance | Index | Number |
| 1* | 68.809 | 1.500 | 1.77250 | 49.77 |
| 2 | 20.441 | 7.306 | | |
| 3 | 52.798 | 1.250 | 1.81600 | 46.57 |
| 4 | 29.959 | d4 | | |
| 5* | −59.094 | 1.200 | 1.77250 | 49.77 |
| 6 | 211.101 | 3.00 | | |
| 7 | 105.261 | 2.638 | 1.66188 | 28.96 |
| 8 | −265.286 | d8 | | |
| 9 | Aperture | 1.200 | | |
| | Stop | | | |
| 10 | 56.822 | 1.500 | 1.88300 | 40.80 |
| 11 | 26.422 | 6.700 | 1.65557 | 54.61 |
| 12 | −110.830 | 0.150 | | |
| 13 | 54.232 | 3.853 | 1.75450 | 51.57 |
| 14 | −177.912 | d14 | | |
| 15 | −68.255 | 0.800 | 1.86474 | 34.78 |
| 16 | 39.643 | 2.829 | 1.92286 | 18.89 |
| 17 | 282.213 | d17 | | |
| 18 | 26.195 | 9.407 | 1.49700 | 81.61 |
| 19 | −21.582 | 0.800 | 1.87958 | 38.30 |
| 20 | −30.240 | 0.150 | | |
| 21 | 225.465 | 0.800 | 1.85817 | 27.56 |
| 22 | 18.289 | 6.259 | 1.49700 | 81.61 |
| 23 | −294.606 | 2.437 | | |
| 24 | −33.532 | 1.000 | 1.88300 | 40.80 |
| 25* | −60.964 | 0.150 | | |
| 26 | 134.747 | 2.833 | 1.79850 | 22.60 |
| 27 | −97.683 | | | |

During zooming from the wide angle end to the telephoto end, a distance d8 between the first lens group GR1 and the second lens group GR2 (aperture stop S), a distance d14 between the second lens group GR2 and the third lens group GR3, and a distance d17 between the third lens group GR3 and the fourth lens group GR4 are changed. Therefore, Table 5 shows values of the respective distances d8, d14, and d17 in the numerical embodiment 2 at the wide angle end (f=16.45), an intermediate focal length (f=24.83) between the wide angle end and the telephoto end, and the telephoto end (f=34.05), together with respective values of the focal length f, the F-number FNO, and the angle of view 2ω. The distance d4 between the object-side sub-group and the image-plane-side sub-group in the first lens group GR1 changes during the focusing.

TABLE 5

| | |
|---|---|
| f = | 16.45~24.83~34.05 |
| FNO = | 2.88~2.88~2.90 |
| 2ω = | 107.2~81.5~63.9 |
| d4 = | 14.924~14.924~14.924 |
| d8 = | 20.095~7.196~1.000 |
| d14 = | 1.697~10.269~17.652 |
| d17 = | 16.705~8.133~0.750 |

The object-side surface (first surface) of the first lens G1, the object-side surface (fifth surface) of the third lens G3, and the image-side surface (25th surface) of the 14th lens G14 are configured with aspheric surfaces. Therefore, Table 6 shows aspherical coefficients of the respective surfaces in the numerical embodiment 2, together with conical constants ε.

TABLE 6

| Surface | | | | | |
|---|---|---|---|---|---|
| No. | ε | A⁴ | A⁶ | A⁸ | A¹⁰ |
| 1 | 9.8668 | 0.10690989 × 10⁻⁴ | −0.14223401 × 10⁻⁷ | 0.17283994 × 10⁻¹⁰ | −0.12132212 × 10⁻¹³ |
| 5 | 1 | −0.30646240 × 10⁻⁵ | −0.44595354 × 10⁻⁸ | 0.11684383 × 10⁻⁹ | −0.35067195 × 10⁻¹² |
| 25 | 1 | 0.13814555 × 10⁻⁴ | 0.27805869 × 10⁻⁷ | 0.10618731 × 10⁻⁹ | 0.56273183 × 10⁻¹² |

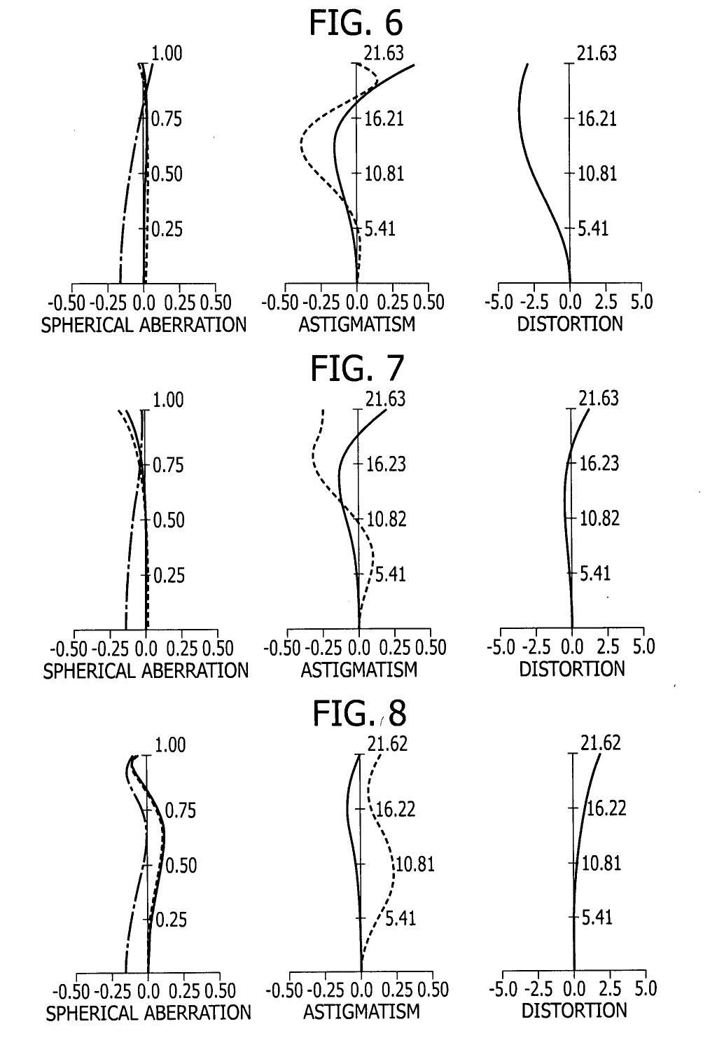

FIG. 6 to FIG. 8 show a spherical aberration, an astigmatism, and distortion, respectively, in focus at infinity in the numerical embodiment 2. FIG. 6 shows the respective aberrations at the wide angle end, FIG. 7 shows those at the intermediate focal length, and FIG. 8 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

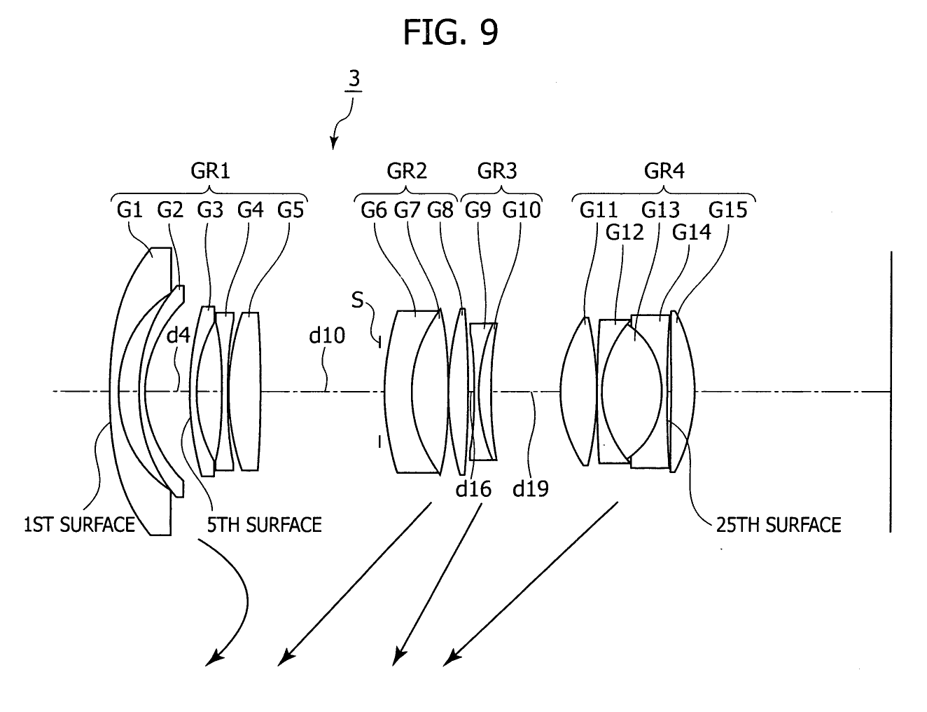

FIG. 9 shows a lens configuration at a wide angle end of a zoom lens 3 according to a third embodiment, and in the figure, a moving trajectory on the optical axis toward a telephoto end of each lens group is indicated by an arrow.

The zoom lens 3 is formed by disposing in the order from the object side to the image-plane side: a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing in the order from the object side to the image-plane side: an object-side sub-group including a negative lens G1 having an aspheric surface on the object side and having a concave surface with a strong curvature on the image side and a negative lens G2 having a concave surface with a strong curvature on the image side; and an image-side sub-group including a negative lens G3 having an aspheric surface on the object side, a negative lens G4, and a positive lens G5. The second lens group GR2 is configured by disposing, in the order from the object side to the image-plane side, a cemented lens formed of a negative lens G6 and a positive lens G7; and a positive lens G8. The third lens group GR3 is configured with a cemented lens formed of a negative lens G9 and the positive lens G10 disposed in the order from the object side to the image-plane side. The fourth lens group GR4 is configured by disposing in the order from the object side to the image-plane side: a positive lens G11; a cemented-triplet lens formed by the negative lens G12, the positive lens G13, and a negative lens G14 having an aspheric surface on the on the image side; and a positive lens G15. The aperture stop S is positioned on the object side of the second lens group GR2, and the image-plane-side sub-group formed of the third lens G3, the fourth lens G4, and the fifth lens G5, of the first lens group GR1, moves on the optical axis to perform the focusing.

Table 7 shows lens data of a numerical embodiment 3 in which specific numerical values are applied to the zoom lens 3 according to the third embodiment.

TABLE 7

| | | Axial | | |
|---|---|---|---|---|
| Surface | Curvature | Surface | Refractive | Abbe |
| No. | Radius | Distance | Index | Number |
| 1* | 82.084 | 1.500 | 1.77250 | 49.36 |
| 2 | 19.243 | 3.979 | | |
| 3 | 25.942 | 1.250 | 1.88300 | 40.80 |
| 4 | 19.503 | d4 | | |
| 5* | 40.579 | 1.000 | 1.77250 | 49.36 |
| 6 | 26.030 | 4.958 | | |
| 7 | −55.189 | 0.900 | 1.83481 | 42.72 |
| 8 | 84.520 | 0.150 | | |
| 9 | 38.164 | 5.911 | 1.64509 | 30.26 |
| 10 | −179.134 | d10 | | |
| | Aperture | | | |
| 11 | Stop | 1.200 | | |
| 12 | 44.176 | 5.000 | 1.89685 | 30.32 |
| 13 | 21.422 | 6.726 | 1.65768 | 53.61 |
| 14 | −63.482 | 0.150 | | |
| 15 | 48.974 | 3.295 | 1.88300 | 40.80 |
| 16 | −156.819 | d16 | | |
| 17 | −69.052 | 0.800 | 1.88300 | 40.80 |
| 18 | 27.740 | 2.143 | 1.92286 | 18.89 |
| 19 | 61.807 | d19 | | |
| 20 | 19.683 | 6.675 | 1.49700 | 81.61 |
| 21 | −45.269 | 0.150 | | |
| 22 | 213.468 | 0.800 | 1.90366 | 31.32 |
| 23 | 16.177 | 10.637 | 1.49700 | 81.61 |
| 24 | −13.544 | 1.000 | 1.77250 | 49.36 |
| 25* | 2872.738 | 0.798 | | |
| 26 | −819.800 | 4.378 | 1.60630 | 34.11 |
| 27 | −25.879 | | | |

During zooming from the wide angle end to the telephoto end, a distance d10 between the first lens group GR1 and the second lens group GR2 (aperture stop S), a distance d16 between the second lens group GR2 and the third lens group GR3, and a distance d19 between the third lens group GR3 and the fourth lens group GR4 are changed. Therefore, Table 8 shows values of the respective distances d10, d16, and d19 in the numerical embodiment 3 at the wide angle end (f=15.40), an intermediate focal length (f=23.25) between the wide angle end and the telephoto end, and the telephoto end (f=33.99), together with respective values of the focal length f, the F-number FNO, and the angle of view 2ω. The distance d4 between the object-side sub-group and the image-plane-side sub-group in the first lens group GR1 changes during the focusing.

TABLE 8

| | |
|---|---|
| f = | 15.40~23.25~33.99 |
| FNO = | 3.58~3.58~3.60 |
| 2ω = | 111.1~84.8~63.7 |
| d4 = | 8.526~8.526~8.526 |
| d10 = | 22.258~10.100~3.388 |
| d16 = | 1.516~6.145~10.215 |
| d19 = | 13.515~8.072~1.623 |

The object-side surface (first surface) of the first lens G1, the object-side surface (fifth surface) of the third lens G3, and the image-side surface (25th surface) of the 14th lens G14 are configured with aspheric surfaces. Therefore, Table 9 shows aspherical coefficients of the respective surfaces in the numerical embodiment 3, together with conical constants ε.

TABLE 9

| Surface | | | | | |
|---|---|---|---|---|---|
| No. | ε | A⁴ | A⁶ | A⁸ | A¹⁰ |
| 1 | 10.1454 | 0.14950114 × 10⁻⁴ | −0.25399939 × 10⁻⁷ | 0.36144960 × 10⁻¹⁰ | −0.26718336 × 10⁻¹³ |
| 5 | 1 | −0.11631935 × 10⁻⁴ | −0.19771836 × 10⁻⁸ | 0.10321854 × 10⁻⁹ | −0.33446521 × 10⁻¹² |
| 25 | 1 | 0.14847184 × 10⁻⁴ | 0.22549428 × 10⁻⁷ | −0.73414138 × 10⁻¹¹ | 0.44985862 × 10⁻¹² |

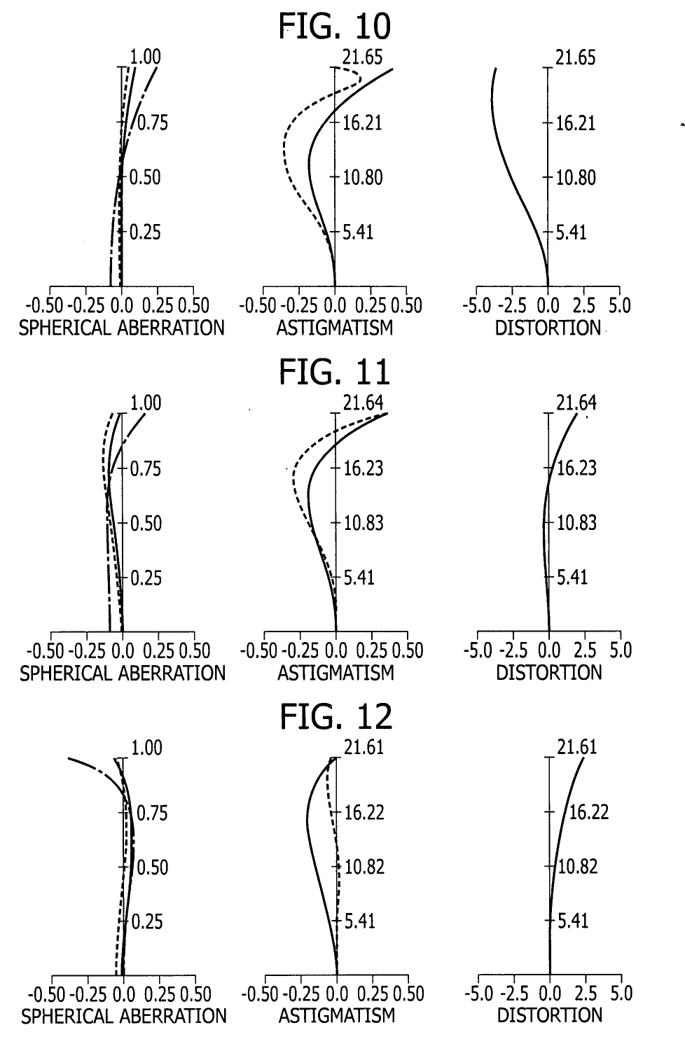

FIG. 10 to FIG. 12 show a spherical aberration, an astigmatism, and distortion, respectively, in focus at infinity in the numerical embodiment 3. FIG. 10 shows the respective aberrations at the wide angle end, FIG. 11 shows those at the intermediate focal length, and FIG. 12 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

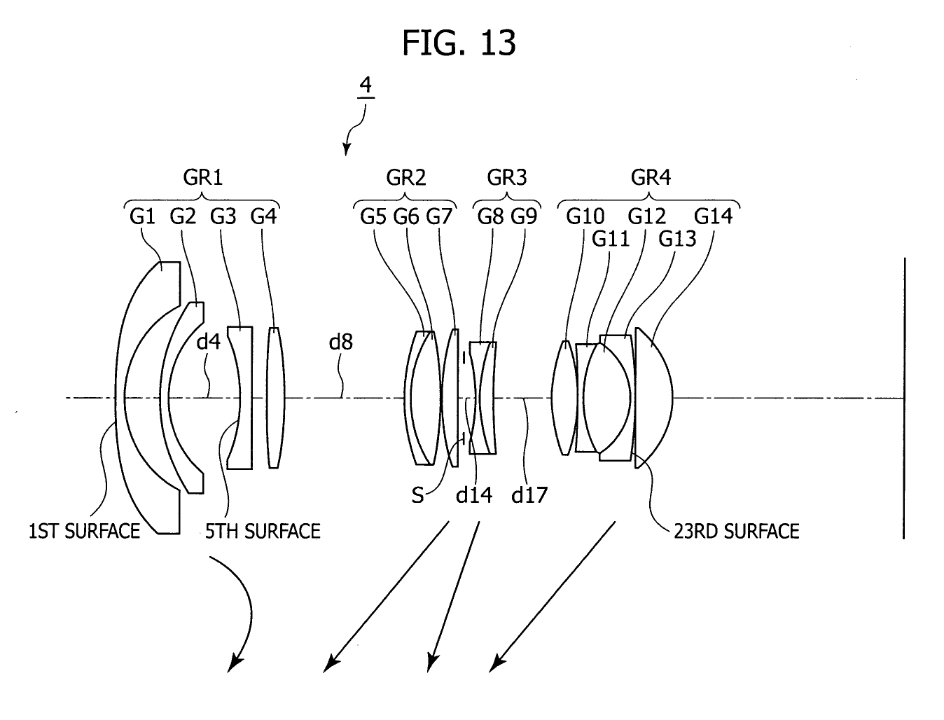

FIG. 13 shows a lens configuration at a wide angle end of a zoom lens 4 according to a fourth embodiment, in which a moving trajectory on the optical axis toward a telephoto end of each lens group is indicated by an arrow.

The zoom lens 4 is formed by aligning in the order from the object side to the image-plane side: a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing in the order from the object side to the image-plane side: an object-side sub-group including a negative lens G1 having an aspheric surface on the object side and having a concave surface with a strong curvature on the image side and a negative lens G2 having a concave surface with a strong curvature on the image side; and an image-side sub-group including a negative lens G3 having an aspheric surface on the object side and a positive lens G4. The second lens group GR2 is configured by disposing, in the order from the object side to the image-plane side, a cemented lens formed of a negative lens G5 and a positive lens G6; and a positive lens G7. The third lens group GR3 is configured with a cemented lens formed of a negative lens G8 and a positive lens G9, disposed in the order from the object side to the image-plane side. The fourth lens group GR4 is configured by disposing in the order from the object side to the image-plane side: a positive lens G10; a cemented-triplet lens formed of a negative lens G11, a positive lens G12, and a negative lens G13 having an aspheric surface on the image side; and a positive lens G14. The aperture stop S is positioned on the image-plane side of the second lens group GR2, and the image-plane-side sub-group formed of the third lens G3 and the fourth lens G4, of the first lens group GR1, moves on the optical axis to perform the focusing.

Table 10 shows lens data of a numerical embodiment 4 in which specific numerical values are applied to the zoom lens 4 according to the fourth embodiment.

TABLE 10

| | | Axial | | |
|---|---|---|---|---|
| | Curvature | Surface | Refractive | Abbe |
| | Radius | Distance | Index | Number |
| 1* | 92.593 | 1.500 | 1.77250 | 49.77 |
| 2 | 16.180 | 5.842 | | |
| 3 | 26.189 | 1.250 | 1.77250 | 49.70 |
| 4 | 15.530 | d4 | | |
| 5* | −28.000 | 1.800 | 1.77250 | 49.77 |
| 6 | 286.819 | 2.299 | | |
| 7 | 119.548 | 3.000 | 1.59303 | 35.81 |
| 8 | −52.007 | d8 | | |
| 9 | 29.576 | 0.800 | 1.87350 | 34.56 |
| 10 | 18.385 | 4.814 | 1.50975 | 56.93 |
| 11 | −44.268 | 0.200 | | |
| 12 | 33.591 | 2.519 | 1.71627 | 51.75 |
| 13 | −273.220 | d13 | | |
| 14 | Aperture | 1.719 | | |
| | Stop | | | |
| 15 | −43.524 | 0.800 | 1.88300 | 40.80 |
| 16 | 20.863 | 2.121 | 1.92286 | 18.89 |
| 17 | 72.967 | d17 | | |
| 18 | 23.537 | 4.097 | 1.49700 | 81.61 |
| 19 | −21.855 | 0.100 | | |
| 20 | −92.568 | 0.800 | 1.88300 | 40.80 |
| 21 | 18.083 | 7.286 | 1.48749 | 70.44 |
| 22 | −9.889 | 0.800 | 1.88263 | 40.52 |
| 23* | −41.796 | 0.200 | | |
| 24 | −138.056 | 5.755 | 1.49700 | 81.61 |
| 25 | −13.552 | | | |

During zooming from the wide angle end to the telephoto end, a distance d8 between the first lens group GR1 and the second lens group GR2, a distance d14 between the second lens group GR2 (aperture stop S) and the third lens group GR3, and a distance d17 between the third lens group GR3 and the fourth lens group GR4 are changed. Therefore, Table 11 shows values of the respective distances d8, d14, and d17 in the numerical embodiment 4 at the wide angle end (f=10.22), an intermediate focal length (f=15.43) between the wide angle end and the telephoto end, and the telephoto end (f=23.32), together with respective values of the focal length f, the F-number FNO, and the angle of view 2ω. The distance d4 between the object-side sub-group and the image-plane-side sub-group in the first lens group GR1 changes during the focusing.

TABLE 11

| | |
|---|---|
| f = | 10.22~15.43~23.32 |
| FNO = | 3.58~3.58~3.60 |
| 2ω = | 111.6~86.3~63.0 |
| d4 = | 11.564~11.564~11.564 |
| d8 = | 19.265~7.708~1.000 |
| d13 = | 1.000~4.876~9.866 |
| d17 = | 9.366~5.490~0.500 |

The object-side surface (first surface) of the first lens G1, the object-side surface (fifth surface) of the third lens G3, and an image-side surface (23rd surface) of the 13th lens G13 are configured by aspheric surfaces. Therefore, Table 12 shows aspherical coefficients of the respective surfaces in the numerical embodiment 4, together with conical constants ε.

TABLE 12

| Surface | | | | | |
|---|---|---|---|---|---|
| No. | ε | A⁴ | A⁶ | A⁸ | A¹⁰ |
| 1 | 16.6861 | 0.31005662 × 10⁻⁴ | −0.71054176 × 10⁻⁷ | 0.13281885 × 10⁻⁹ | −0.10610991 × 10⁻¹² |
| 5 | 1 | −0.81332133 × 10⁻⁵ | 0.39844381 × 10⁻⁷ | 0.30106097 × 10⁻⁹ | −0.20748486 × 10⁻¹¹ |
| 23 | 1 | 0.30846271 × 10⁻⁴ | 0.10339208 × 10⁻⁶ | −0.93978784 × 10⁻⁹ | 0.19100956 × 10⁻¹¹ |

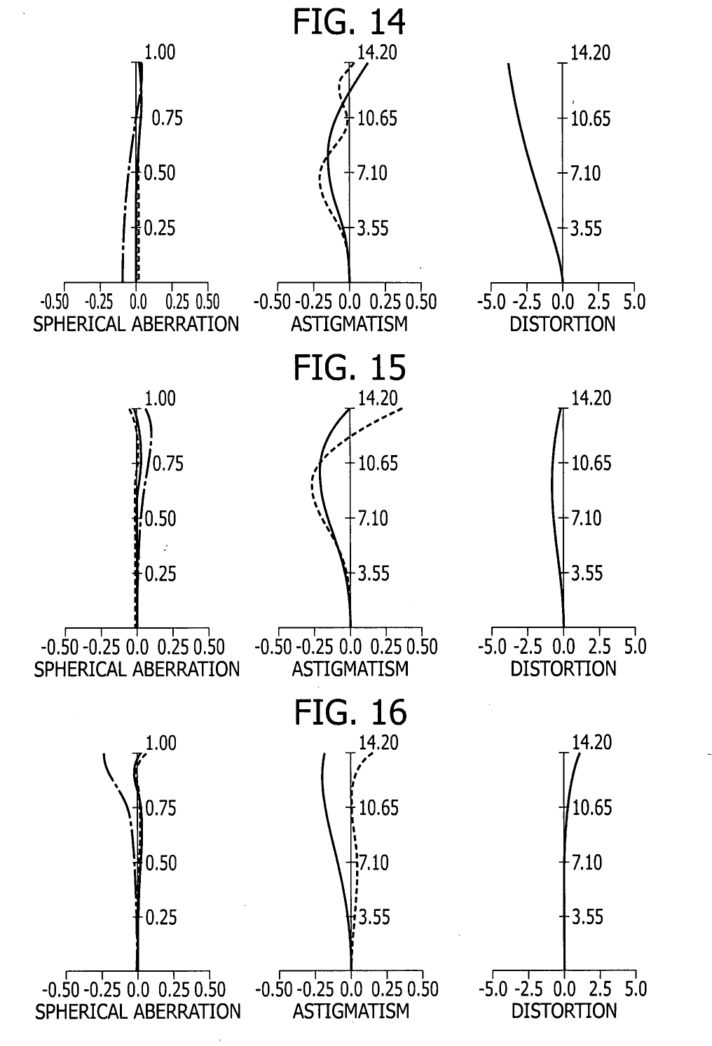

FIG. 14 to FIG. 16 show a spherical aberration, an astigmatism, and distortion, respectively, in focus at infinity in the numerical embodiment 4. FIG. 14 shows the respective aberrations at the wide angle end, FIG. 15 shows those at the intermediate focal length, and FIG. 16 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

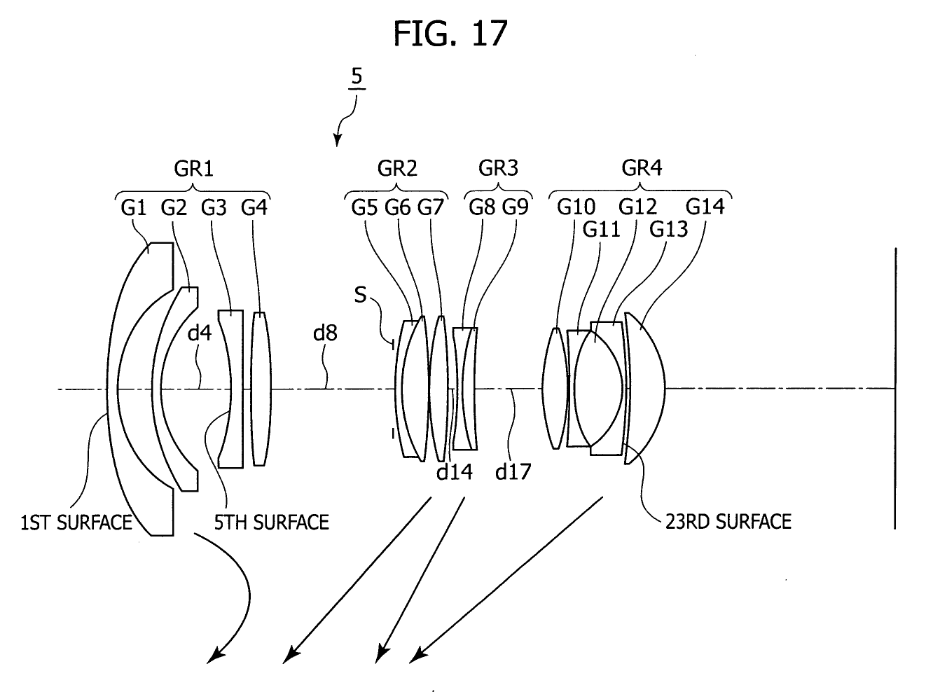

FIG. 17 shows a lens configuration at a wide angle end of a zoom lens 5 according to a fifth embodiment, in which a moving trajectory on the optical axis toward a telephoto end of each lens group is indicated by an arrow.

The zoom lens 5 is formed by aligning in the order from the object side to the image-plane side: a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing in the order from the object side to the image-plane side: an object-side sub-group including a negative lens G1 having an aspheric surface on the object side and having a concave surface with a strong curvature on the image side and a negative lens G2 having a concave surface with a strong curvature on the image side; and an image-side sub-group including a negative lens G3 having an aspheric surface on the object side and a positive lens G4. The second lens group GR2 is configured by disposing in the order from the object side to the image-plane side: a cemented lens formed of a negative lens G5 and the positive lens G6; and a positive lens G7. The third lens group GR3 is configured with a cemented lens formed of a negative lens G8 and a positive lens G9, disposed in the order from the object side to the image-plane side. The fourth lens group GR4 is configured by disposing in the order from the object side to the image-plane side: a positive lens G10; a cemented-triplet lens formed of a negative lens G11, a positive lens G12, and a negative lens G13 having an aspheric surface on the image side; and a positive lens G14. The aperture stop S is positioned on the object side of the second lens group GR2, and the image-plane-side sub-group formed of the third lens G3 and the fourth lens G4, of the first lens group GR1, moves on the optical axis to perform the focusing.

Table 13 shows lens data of a numerical embodiment 5 in which specific numerical values are applied to the zoom lens 5 according to the fifth embodiment.

TABLE 13

| | | Axial | | |
|---|---|---|---|---|
| Surface | Curvature | Surface | Refractive | Abbe |
| No. | Radius | Distance | Index | Number |
| 1* | 92.593 | 1.500 | 1.77250 | 49.77 |
| 2 | 16.363 | 5.787 | | |
| 3 | 25.165 | 1.250 | 1.77250 | 49.70 |
| 4 | 14.839 | d4 | | |
| 5* | −28.125 | 1.800 | 1.77250 | 49.70 |
| 6 | 1025.725 | 1.463 | | |
| 7 | 136.186 | 3.000 | 1.62249 | 32.33 |
| 8 | −58.824 | d8 | | |
| 9 | Aperture | 0.500 | | |
| | Stop | | | |
| 10 | 33.620 | 1.000 | 1.87496 | 35.40 |
| 11 | 19.267 | 4.408 | 1.52510 | 54.00 |
| 12 | −51.151 | 0.200 | | |
| 13 | 33.203 | 2.825 | 1.65662 | 54.55 |
| 14 | −96.772 | d14 | | |
| 15 | −43.936 | 0.800 | 1.88300 | 40.80 |
| 16 | 24.382 | 2.0404 | 1.92286 | 18.89 |
| 17 | 108.435 | d17 | | |
| 18 | 22.639 | 4.014 | 1.49700 | 81.61 |
| 19 | −24.676 | 0.100 | | |
| 20 | −169.212 | 0.800 | 1.88300 | 40.80 |
| 21 | 15.610 | 7.646 | 1.48749 | 70.44 |
| 22 | −9.911 | 0.800 | 1.88300 | 40.80 |
| 23* | −35.622 | 0.557 | | |
| 24 | −54.659 | 5.367 | 1.49700 | 81.61 |
| 25 | −13.399 | | | |

During zooming from the wide angle end to the telephoto end, a distance d8 between the first lens group GR1 and the second lens group GR2 (aperture stop S), a distance d14 between the second lens group GR2 and the third lens group GR3, and a distance d17 between the third lens group GR3 and the fourth lens group GR4 are changed. Therefore, Table 14 shows values of the respective distances d8, d14, and d17 in the numerical embodiment 5 at the wide angle end (f=10.22), an intermediate focal length (f=15.43) between the wide angle end and the telephoto end, and the telephoto end (f=23.32), together with respective values of the focal length f, the F-number FNO, and the angle of view 2ω. The distance d4 between the object-side sub-group and the image-plane-side sub-group in the first lens group GR1 changes during the focusing.

TABLE 14

| | |
|---|---|
| f = | 10.22~15.43~23.32 |
| FNO = | 3.58~3.58~3.60 |
| 2ω = | 111.6~86.4~63.0 |
| d4 = | 11.400~11.400~11.400 |
| d8 = | 19.316~8.102~1.516 |
| d14 = | 1.490~6.006~11.757 |
| d17 = | 10.767~6.251~0.500 |

The object-side surface (first surface) of the first lens G1, the object-side surface (fifth surface) of the third lens G3, and the image-side surface (23rd surface) of the 13th lens G13 are configured by aspheric surfaces. Therefore, Table 15 shows aspherical coefficients of the respective surfaces in the numerical embodiment 5, together with conical constants ε.

TABLE 15

| Surface | | | | | |
|---|---|---|---|---|---|
| No. | ε | A⁴ | A⁶ | A⁸ | A¹⁰ |
| 1 | 16.8790 | 0.30398945 × 10⁻⁴ | −0.69991481 × 10⁻⁷ | 0.13273466 × 10⁻⁹ | −0.10788258 × 10⁻¹² |
| 5 | 1 | −0.81161548 × 10⁻⁵ | 0.85540282 × 10⁻⁷ | −0.22574794 × 10⁻⁹ | −0.16839086 × 10⁻¹² |
| 23 | 1 | 0.27009907 × 10⁻⁴ | 0.78702227 × 10⁻⁷ | −0.55586073 × 10⁻⁹ | 0.41561089 × 10⁻¹² |

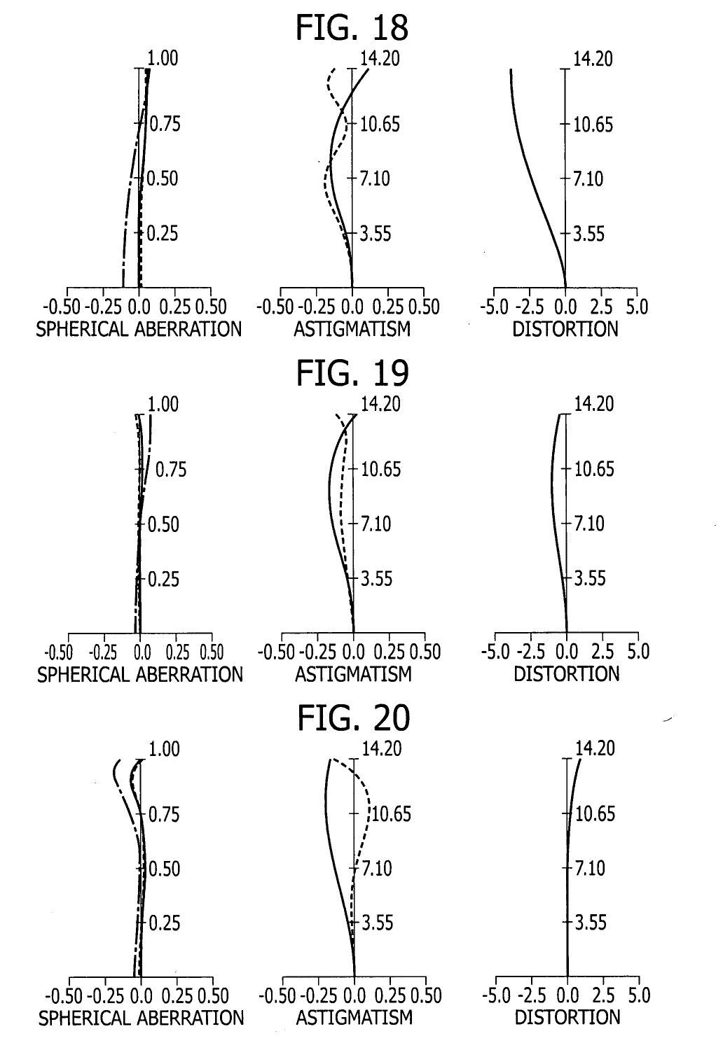

FIG. 18 to FIG. 20 show a spherical aberration, an astigmatism, and distortion, respectively, in focus at infinity in the numerical embodiment 5. FIG. 18 shows the respective aberrations at the wide angle end, FIG. 19 shows those at the intermediate focal length, and FIG. 20 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

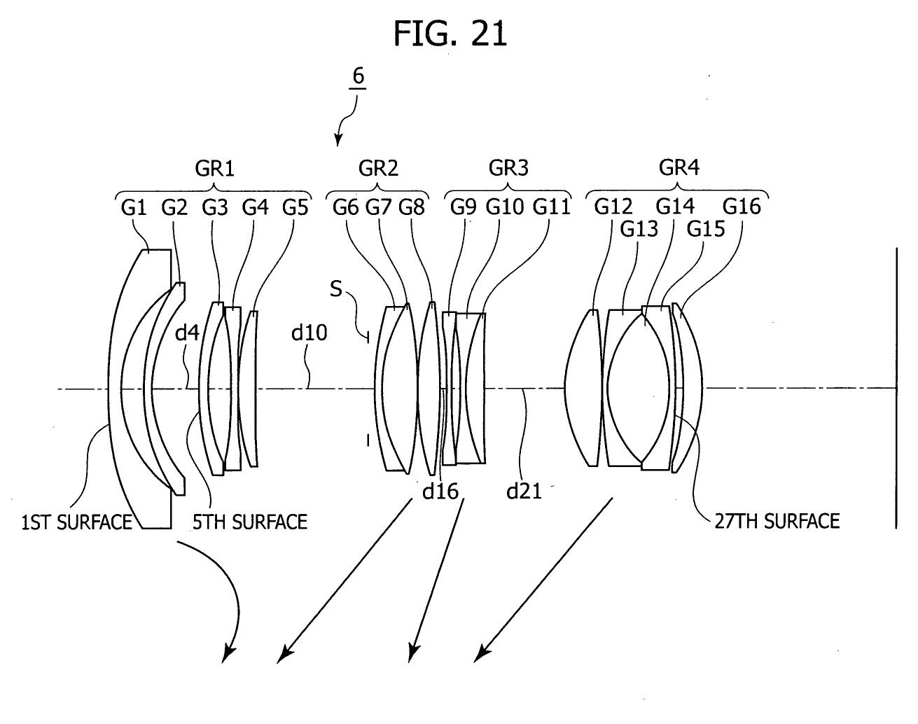

FIG. 21 shows a lens configuration at a wide angle end of a zoom lens 6 according to a sixth embodiment, in which a moving trajectory on the optical axis toward a telephoto end of each lens group is indicated by an arrow.

The zoom lens 6 is formed by aligning in the order from the object side to the image-plane side: a first lens group GR1 having a negative refractive power; a second lens group GR2 having a positive refractive power; a third lens group GR3 having a negative refractive power; and a fourth lens group GR4 having a positive refractive power.

The first lens group GR1 is configured by disposing, in the order from the object side to the image-plane side: an object-side sub-group including a negative lens G1 having an aspheric surface on the object side and having a concave surface with a strong curvature on the image side and a negative lens G2 having a concave surface with a strong curvature on the image side; and an image-side sub-group including a negative lens G3 having an aspheric surface on the object side, a negative lens G4, and a positive lens G5. The second lens group GR2 is configured by disposing, from the object side to the image-plane side, a cemented lens formed of a negative lens G6 and a positive lens G7; and a positive lens G8. The third lens group GR3 is configured by disposing, in the order from the object side to the image-plane side, a negative lens G9; and a cemented lens formed by a negative lens G10 and a positive lens G11. The fourth lens group GR4 is configured by disposing, in the order from the object side to the image-plane side: a positive lens G12; a cemented-triplet lens formed of a negative lens G13, a positive lens G14, and a negative lens G15 having an aspheric surface on the image side; and a positive lens G16. The aperture stop S is positioned on the object side of the second lens group GR2, and the image-plane-side sub-group formed of the third lens G3, the fourth lens G4, and the fifth lens G5, of the first lens group GR1, moves on the optical axis to perform the focusing.

Table 16 shows lens data of a numerical embodiment 6 in which specific numerical values are applied to the zoom lens 6 according to the sixth embodiment.

TABLE 16

| | | Axial | | |
|---|---|---|---|---|
| Surface | Curvature | Surface | Refractive | Abbe |
| No. | Radius | Distance | Index | Number |
| 1* | 120.28252 | 2.000 | 1.77250 | 49.36 |
| 2 | 22.96211 | 4.450 | | |
| 3 | 34.21556 | 1.500 | 1.88300 | 40.80 |
| 4 | 24.87049 | d4 | | |
| 5* | 45.93967 | 1.600 | 1.77250 | 49.36 |
| 6 | 34.90506 | 4.643 | | |
| 7 | −73.73451 | 1.100 | 1.83481 | 42.72 |
| 8 | 139.49764 | 0.150 | | |
| 9 | 43.53072 | 3.109 | 1.76182 | 26.61 |
| 10 | 135.23638 | d10 | | |
| 11 | 0.00000 | 1.600 | | |
| 12 | 56.80411 | 1.200 | 1.90366 | 31.32 |
| 13 | 26.87031 | 6.852 | 1.63854 | 55.45 |
| 14 | −70.95414 | 0.150 | | |
| 15 | 58.22979 | 3.910 | 1.88300 | 40.80 |
| 16 | −157.33141 | d16 | | |
| 17 | −125.91810 | 1.000 | 1.83481 | 42.72 |
| 18 | 146.07859 | 1.790 | | |
| 19 | −70.19297 | 0.900 | 1.69680 | 55.46 |
| 20 | 35.33390 | 3.445 | 1.84666 | 23.78 |
| 21 | 269.34286 | d21 | | |
| 22 | 23.38634 | 6.930 | 1.45650 | 90.27 |
| 23 | −102.85219 | 0.150 | | |
| 24 | 70.11934 | 1.100 | 1.90366 | 31.32 |
| 25 | 17.92286 | 11.741 | 1.49700 | 81.61 |
| 26 | −21.36752 | 1.200 | 1.77250 | 49.36 |
| 27* | −61.82621 | 1.533 | | |
| 28 | −50.34053 | 3.584 | 1.51823 | 58.96 |
| 29 | −27.22193 | | | |

During zooming from the wide angle end to the telephoto end, a distance d10 between the first lens group GR1 and the second lens group GR2 (aperture stop S), a distance d16 between the second lens group GR2 and the third lens group GR3, and a distance d21 between the third lens group GR3 and the fourth lens group GR4 are changed. Therefore, Table 17 shows values of the respective distances d10, d16, and d21 in the numerical embodiment 6 at the wide angle end (f=16.42), the intermediate focal length (f=24.01) between the wide angle end and the telephoto end, and the telephoto end (f=34.01), together with respective values of the focal length f, the F-number FNO, and the angle of view 2ω. The distance d4 between the object-side sub-group and the image-plane-side sub-group in the first lens group GR1 changes during the focusing.

TABLE 17

| | |
|---|---|
| f = | 16.42~24.01~34.01 |
| FNO = | 2.88~2.88~2.90 |
| 2ω = | 107.50~83.0~63.7 |
| d4 = | 9.220~9.220~9.220 |
| d10 = | 21.888~10.641~4.145 |
| d16 = | 1.500~7.418~11.808 |
| d21 = | 15.476~8.248~1.200 |

The object-side surface (first surface) of the first lens G1, the object-side surface (fifth surface) of the third lens G3, and an image-side surface (27th surface) of the 15th lens G15 are configured with aspheric surfaces. Therefore, Table 18 shows aspherical coefficients of the respective surfaces in the numerical embodiment 6, together with conical constants ε.

TABLE 18

| Surface | | | | | | |
|---|---|---|---|---|---|---|
| No. | ε | A⁴ | A⁶ | A⁸ | A¹⁰ | A¹² |
| 1 | 12.5720 | 0.112012 × 10⁻⁴ | −0.160907 × 10⁻⁷ | 0.231863 × 10⁻¹⁰ | −0.213231 × 10⁻¹³ | 0.962746 × 10⁻¹⁷ |
| 5 | 1 | −0.750513 × 10⁻⁵ | −0.931964 × 10⁻⁸ | 0.137423 × 10⁻⁹ | −0.545020 × 10⁻¹² | 0.715615 × 10⁻¹⁵ |
| 27 | 1 | 0.117695 × 10⁻⁴ | 0.220234 × 10⁻⁸ | 0.152244 × 10⁻⁹ | −0.710637 × 10⁻¹² | 0.200514 × 10⁻¹⁴ |

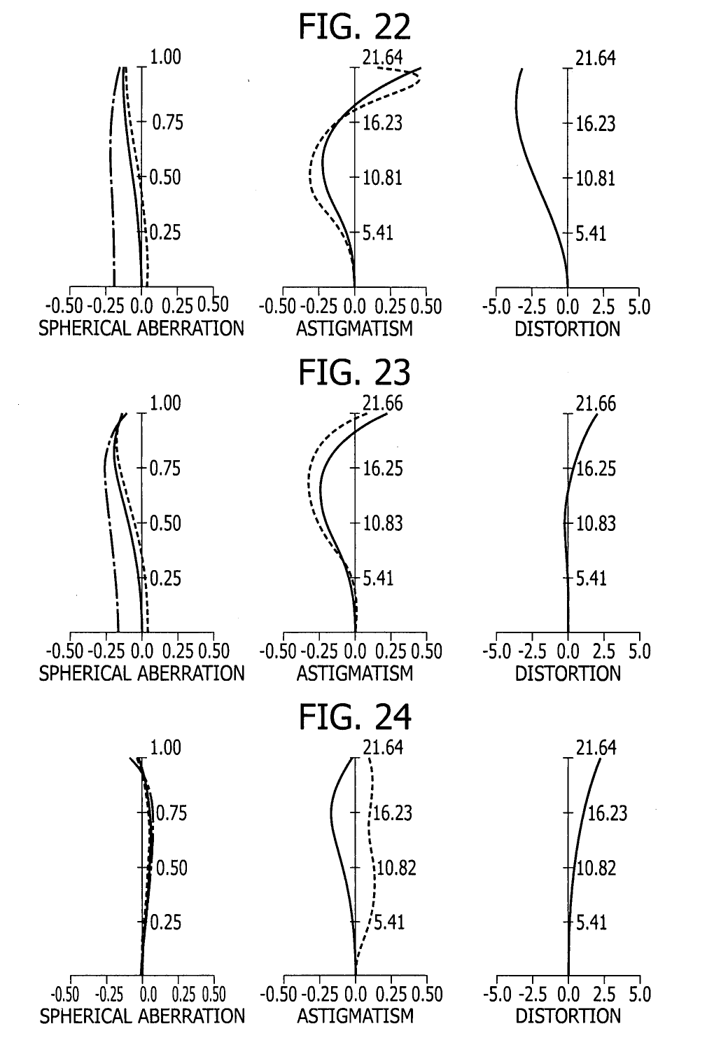

FIG. 22 to FIG. 24 show a spherical aberration, an astigmatism, and distortion, respectively, in focus at infinity in the numerical embodiment 6. FIG. 22 shows the respective aberrations at the wide angle end, FIG. 23 shows those at the intermediate focal length, and FIG. 24 shows those at the telephoto end. In a spherical aberration chart, a vertical axis represents a ratio of the spherical aberration to a full-aperture F number, and a horizontal axis represents defocus. In the chart, a solid line represents a spherical aberration at a d-line, a dashed line represents that at a C-line, and a dot-dashed line represents that at a g-line, respectively. In an astigmatism chart, a vertical axis represents an image height, a horizontal axis represents focus, a solid line represents a sagittal image plane, and a dashed line represents a meridional image plane. In a distortion chart, a vertical axis represents an image height.

The following Table 19 shows numerical values and values corresponding to the respective conditional expressions for evaluating conditions of the conditional expressions (1) to (4) of the numerical embodiments 1 to 6.

TABLE 19

| Conditional | Embodiment | Embodiment | Embodiment | Embodiment | Embodiment | Embodiment |
|---|---|---|---|---|---|---|
| Expression | 1 | 2 | 3 | 4 | 5 | 6 |
| (1)f4/f1 | −3.32 | −2.87 | −3.53 | −3.07 | −3.31 | −2.63 |
| (2)D3/f1 | −1.21 | −1.33 | −1.37 | −1.33 | −1.32 | −1.50 |
| (3)f11/f12 | 0.23 | 0.18 | 0.34 | 0.19 | 0.18 | 0.28 |
| (4) | −16.48 | −10.06 | −21.97 | −35.09 | −35.22 | −23.68 |
| $\frac{( \vert X \vert - \vert X 0 \vert )}{( C 0 \times ( N - N ) \times f 1 )}$ | | | | | | |

In the numerical embodiments 1 to 6, the conditional expressions (1) to (4) are satisfied, and as shown in the respective aberration charts, each aberration is corrected with good balance at the wide angle end, the intermediate focal length between the wide angle end and the telephoto end, and the telephoto end.

Subsequently, a description is given of an imaging apparatus according to an embodiment of the present invention.

The imaging apparatus according to the embodiment of the present invention is provided with a zoom lens and an image sensor for converting an optical image formed by the zoom lens into an electric signal. The zoom lens is configured by aligning, in an order from the object side to the image side, a first lens group having a negative refractive power; a second lens group having a positive refractive power; a third lens group having a negative refractive power; and a fourth lens group having a positive refractive power. During power variation from a wide angle end to a telephoto end, each group is moved in the optical axis direction, and the conditional expression (1) is satisfied:

−5<f4/f1<−2.6, (1)

where:
f1 is a focal length of the first lens group; and
f4 is a focal length of the fourth lens group.

Therefore, the imaging apparatus according to the embodiment of the present invention enables miniaturization and securing a necessary back focus, and is provided with a zoom lens permitting reducing curvature of field that occurs in the first lens group.

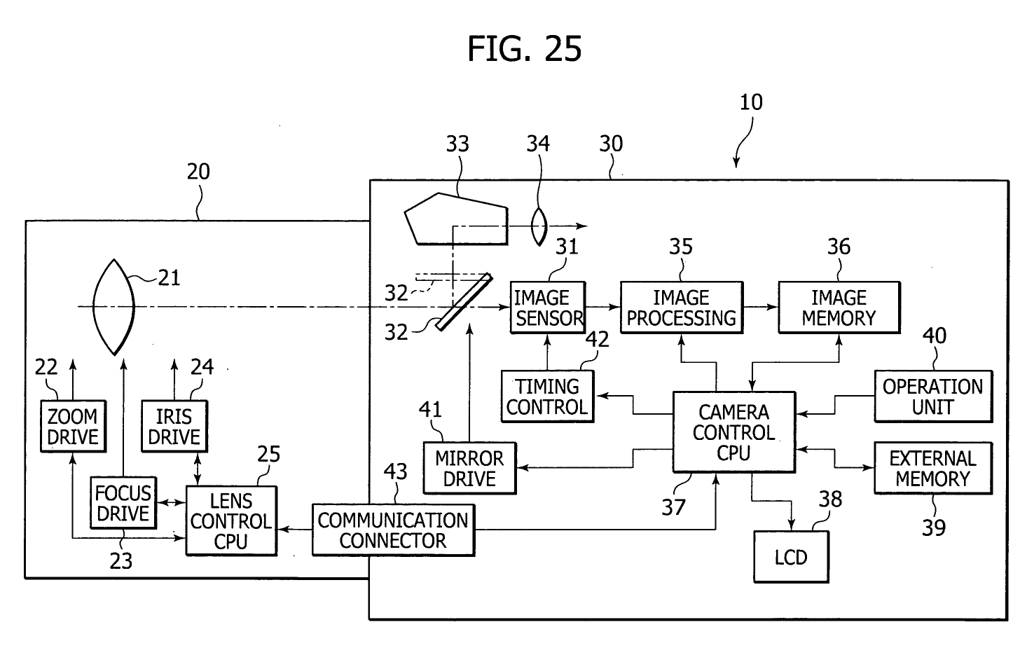

Subsequently, a specific example of the imaging apparatus of the embodiment is shown in a block diagram in FIG. 25.

A digital camera 10 is configured as lens interchangeable, so-called a single-lens reflex camera. In the digital camera 10, a lens unit 20 is used to be detachable to and from a camera main body 30 provided with the image sensor.

The lens unit 20 is provided with a zoom lens or a single focus lens; a drive unit for driving parts of the lens; and a controller for driving and controlling the drive unit. As the lens, it may be possible to use the aforementioned zoom lens of the present invention. That is, it may be possible to use the zoom lenses 1 to 6 shown in the respective embodiments and the numerical embodiments thereof, or a zoom lens of the present invention carried out in modes other than those shown in the embodiments and the numerical embodiment. The lens, in a case of a zoom lens 21, is provided with: drive units including a zoom drive unit 22 for moving a predetermined lens group at the time of zooming, for example, the image-plane-side sub-group of the first lens group, a focus drive unit 23 for moving the predetermined lens group at the time of focusing, and an iris drive unit 24 for changing an aperture diameter of the aperture stop; and a lens control CPU (Central Processing Unit) 25 for driving and controlling these drive units.

The camera main body 30 is provided with an image sensor 31 for converting an optical image formed by the zoom lens 21 into an electric signal. Before the image sensor 31, there is disposed a flip-up mirror 32 to introduce light from the zoom lens 21 to a pentaprism 33. The resultant light is further introduced to an eyepiece 34. As a result, a photographer can see the optical image formed by the zoom lens 21 through the eyepiece 34.

CCD (Charge Coupled Device), CMOS (Complementary Metal-Oxide Semiconductor), or the like, for example, are applicable to the image sensor 31. An electric image signal output from the image sensor 31 is subject to various processes in an image processing circuit 35, and thereafter, the processed signal is data-compressed according to a predetermined system to be temporarily saved as image data in an image memory 36.

A camera control CPU (Central Processing Unit) 37 generally controls a whole of the camera main body 30 and the lens unit 20. The camera control CPU 37 retrieves the image data temporarily saved in the image memory 36 to display on a liquid crystal display device 38, or to save in an external memory 39. Alternatively, the camera control CPU 37 reads out the image data saved in the external memory 39 to display on the liquid crystal display device 38. A signal from an operation unit 40 such as a shutter release switch and a zooming switch is input to the camera control CPU 37, and various units are controlled by the signal from the operation unit 40. For example, when the shutter release switch is operated, an instruction is issued from the camera control CPU 37 to a mirror drive unit 41, and in addition, an instruction is issued to a timing control unit 42. The flip-up mirror 32 is then flipped up by the mirror drive unit 41 as indicated by a double dotted chain line in the figure, and thus, a light beam from the zoom lens 21 is input to the image sensor 31, and a signal read-out timing of the image sensor is controlled by the timing control unit 42. The camera main body 30 and the lens unit 20 are connected by a communication connector 43. When a signal regarding control of the zoom lens 21, an AF (Auto Focus) signal, an AE (Auto Exposure) signal, and a zooming signal, for example, are transmitted from the camera control CPU 37 via the communication connector 43 to the lens control CPU 25, the zoom drive unit 21, the focus drive unit 23, the iris drive unit 24 are controlled by the lens control CPU 25 to bring the zoom lens 21 in a predetermined state.

In the embodiments, the imaging apparatus is shown as a single-lens reflex camera. However, the imaging apparatus may be applied as a lens fixed type camera. Alternatively, the imaging apparatus may be applied not only to a digital camera but also to a silver halide film type camera.

The shapes and numerical values of each of the aforesaid embodiments are mere examples to be referenced in implementing the present invention, and they are not intended to restrict the technological scope of the present invention.

According to the present invention, it may become possible to achieve miniaturization and secure a necessary back focus.

It should be understood by those skilled in the art that various modifications, combinations, sub-combinations and alterations may occur depending on design requirements and other factors insofar as they are within the scope of the appended claims or the equivalents thereof.

### CROSS REFERENCES TO RELATED APPLICATIONS

The present document contains subject matter related to Japanese Patent Application JP 2006-336125 filed in the Japanese Patent Office on Dec. 13, 2006, the entire contents of which being incorporated herein by reference.

What is claimed is:

1. A zoom lens, comprising, in an order from an object side to an image side:
a first lens group having a negative refractive power;
a second lens group having a positive refractive power;
a third lens group having a negative refractive power; and
a fourth lens group having a positive refractive power, wherein:
during power variation from a wide angle end to a telephoto end, each group is moved in an optical axis direction, and a following conditional expression (1) is satisfied:
−5<f4/f1<−2.6, (1)
where:
f1 is a focal length of the first lens group; and
f4 is a focal length of the fourth lens group.

2. The zoom lens according to claim 1, wherein a following conditional expression (2) is satisfied:
−1.7<D3/f1<−0.95, (2)
where:
D3: an optical path diameter on an on-axis bundle on a surface closest to the object side of the third lens group at the telephoto end.

3. The zoom lens according to claim 1, wherein a whole of the first lens group is moved to the optical axis direction to perform focusing on a close subject.

4. The zoom lens according to claim 1, wherein:
the first lens group is configured with an object-side sub-group positioned on the object side and an image-plane-side sub-group positioned on an image-plane side, and
the image-plane-side sub-group is moved to perform focusing on a close subject.

5. The zoom lens according to claim 4, wherein:
a following conditional expression (3) is satisfied:
0.15<f11/f12<0.45, (3)
where:
f11 is a focal length of the object-side sub-group in the first lens group; and
f12 is a focal length of the image-plane-side sub-group in the first lens group.

6. The zoom lens according to claim 1, comprising an aspheric surface disposed, on a surface closest to the object side of the first lens group, such that the further away from the optical axis, the stronger a positive refractive force.

7. An imaging apparatus, comprising:
a zoom lens; and
an image sensor for converting an optical image formed by the zoom lens into an electric signal, wherein:
the zoom lens includes, in an order from an object side to an image side:
a first lens group having a negative refractive power;
a second lens group having a positive refractive power;
a third lens group having a negative refractive power; and
a fourth lens group having a positive refractive power are aligned, and
during power variation from a wide angle end to a telephoto end, each group is moved in an optical axis direction, and a following conditional expression (1) is satisfied:
−5<f4/f1<−2.6, (1)
where:
f1 is a focal length of the first lens group; and
f4 is a focal length of the fourth lens group.
